(19) United States
(12) Patent Application Publication
(10) Pub. No.: US 2024/0210250 A1
(43) Pub. Date: Jun. 27, 2024

(54) COLD POOL DETECTION METHOD AND SYSTEM

(71) Applicant: Korea Institute of Ocean Science & Technology, Busan (KR)

(72) Inventors: Chan Su YANG, Busan (KR); Won Jun CHOI, Busan (KR)

(21) Appl. No.: 18/536,481

(22) Filed: Dec. 12, 2023

(30) Foreign Application Priority Data
Dec. 23, 2022 (KR) 10-2022-0183275

(51) Int. Cl. G01K 1/02

(52) U.S. Cl. CPC G01K 1/026; G01K 2213/00

(57) ABSTRACT

A cold pool detection method and system is proposed. The cold pool detection method is characterized by including collecting and generating sea surface temperature data in a target area, partitioning the target area and generating partitioned areas, setting up clusters of each partitioned area, and sorting out cold pool candidate groups and detecting a cold pool. Here, the setting up of the clusters of each partitioned area is characterized by including setting clustering values for setting the clusters of each partitioned area, and setting the number of the clusters of each partitioned area. The cold pool detection method and system is capable of partitioning a target area, clustering partitioned areas to establish clusters, and using a standard deviation to determine a cold pool.

### CROSS REFERENCE TO RELATED APPLICATION

The present application claims priority to Korean Patent Application No. 10-2022-0183275, filed Dec. 23, 2022, the entire contents of which are incorporated herein for all purposes by this reference.

### BACKGROUND OF THE INVENTION

### Field of the Invention

The present disclosure relates to a cold pool detection method and system and, particularly, to a cold pool detection method and system for partitioning a target area, clustering the partitioned areas to establish clusters, and using a standard deviation to determine a cold pool.

### Description of the Related Art

Convection activity occurs actively between the atmosphere and the ocean by heat exchange through the sea surface, and such interaction transfers heat, energy, water vapor, etc. to the ocean, thereby maintaining thermal balance between the atmosphere and the ocean.

However, when water temperature is higher than air temperature, heat is conducted from seawater to the atmosphere, and when water temperature is lower than air temperature, heat is conducted from the atmosphere to the seawater, thereby generating sensible heat.

The energy exchange between the atmosphere and the ocean is very important as a factor in explaining not only synoptic-scale meteorological phenomena but also meso-scale meteorological phenomena, so research is continually being conducted thereon.

Meanwhile, the ocean serves as a lower boundary of the atmosphere and acts as a factor causing various physical changes in the atmosphere, and in particular, sea surface temperature is known to be a major factor causing thermal alteration in a lower part of air current passing over the sea surface.

In general, the temperature of the ocean decreases as the depths of the ocean increases, and water temperature in a deep layer of the ocean becomes much lower than water temperature in a surface layer of the ocean.

Such a phenomenon is caused by a relationship between density and temperature in sea water, and thus the temperature of the sea has a vertical structure.

A cold pool refers to a sea area where a water temperature of a sea surface is lower than that of a surrounding area by more than five degrees, and is mainly present around a southern coastline of the East Sea in South Korea.

The cause of occurrence of a cold pool is due to relationships between winds and ocean currents.

When a southerly seasonal wind blows in the summer, coastal surface water moves toward a distant sea by Ekman spiral motion (i.e., Ekman transport). In this case, to compensate for this movement, there occurs an upwelling phenomenon in which low-temperature seawater rises from a bottom layer of coastal water to a surface layer of the ocean, and the excessive upwelling forms a cold pool.

Because of causing rapid changes in water temperature, a cold pool is the root cause of various marine disasters, such as the death of farmed fish, safety accidents related to marine sports, and thick sea fog threatening the safety of ships and causing subtropical squalls, and thus developing technology for detecting and predicting the cold pool is required.

Up to the present time, observations of cold pool phenomena have been made by using field data on surface water temperature as well as using earth observation satellite images obtained from the Cheollian ocean observation satellite, geostationary meteorological satellites, etc.

Because the field data is obtained by observing cold pools for some static points, there is a limitation in that spatial analysis is unable to be performed.

To complement this limitation, Earth observation satellites have been actively used recently, but there is a limitation in using only the Earth observation satellites that obtain only information on solar radiant energy reflected from the crust of the Earth or information on radiant energy of the Earth.

Accordingly, developing a new technology that may efficiently detect cold pools is required.

### DOCUMENTS OF RELATED ART

### Patent Documents

(Patent Document 1) Korean Patent No. 10-1319370

### SUMMARY OF THE INVENTION

An objective of the present disclosure is for partitioning a target area, clustering partitioned areas to establish clusters, and using a standard deviation to determine a cold pool.

According to the present disclosure to achieve the above objective, there is provided a cold pool detection method characterized by including: collecting and generating sea surface temperature data in a target area; partitioning the target area and generating partitioned areas; setting up clusters of each partitioned area; and sorting out cold pool candidate groups and detecting a cold pool.

Here, in particular, the setting up of the clusters of each partitioned area may be characterized by including: setting clustering values for setting the clusters of each partitioned area; and setting the number of the clusters of each partitioned area.

Here, in particular, the clustering values may be characterized by being sea surface temperatures at 1 km resolution.

Here, in particular, the method is characterized in that the sorting out of the cold pool candidate groups and the detecting of the cold pool may include: sorting out a primary candidate group from the partitioned areas partitioned from the partitioning of the target area and the generating of the partitioned areas; and sorting out a secondary candidate group from the primary candidate group, the sorting out of the primary candidate group may classify any partitioned area into the primary candidate group in a case where an overall standard deviation of the partitioned area is 0.6° C. or more, and the sorting out of the secondary candidate group may classify the partitioned area into the second candidate group in a case where among each of the clusters in the partitioned area classified into the primary candidate group, a value obtained by subtracting an average temperature of each cluster having a lowest temperature from an average temperature of each cluster having a highest temperature is 2° C. or more.

Here, in particular, the sorting out of the cold pool candidate groups and the detecting of the cold pool may be characterized to further include determining the cold pool by confirming the secondary candidate group and buoy information, confirm the buoy information on cluster positions of the secondary candidate group, and determine the cold pool in a case where water temperature information of a corresponding buoy is within a water temperature range of the corresponding secondary candidate group.

In addition, according to the present disclosure to achieve the above objective, there is provided a cold pool detection system characterized by including: a data collection and generation unit for collecting and generating sea surface temperature data in a target area; an area partition unit for partitioning the target area and generating partitioned areas; a cluster setting unit for setting clusters of each partitioned area; and a cold pool determination unit for sorting out cold pool candidate groups and detecting a cold pool.

Here, in particular, the cluster setting unit may be characterized by including: a clustering value setting module configured to set clustering values for setting the clusters of the partitioned areas; and a cluster count setting module configured to set the number of the clusters of each partitioned area.

Here, in particular, the clustering values may be characterized by being sea surface temperatures at 1 km resolution.

Here, in particular, the system is characterized in that the cold pool determination unit may include: a primary candidate group classification module for sorting out a primary candidate group from the partitioned areas partitioned by the area partition unit; and a secondary candidate group classification module for sorting out a secondary candidate group from the primary candidate group sorted out by the primary candidate group classification module, the primary candidate group classification module may classify any partitioned area into the primary candidate group in a case where an overall standard deviation of the partitioned area is 0.6° C. or more, and the secondary candidate group classification module may classify the partitioned area into the secondary candidate group in a case where among each of the clusters of the partitioned area classified into the primary candidate group, a value obtained by subtracting an average temperature of each cluster having a lowest temperature from an average temperature of each cluster having a highest temperature is 2° C. or more.

Here, in particular, the system is characterized in that the cold pool determination unit may further include: a cold pool determination module for determining the cold pool by confirming the secondary candidate group and buoy information, and the cold pool determination module may confirm the buoy information of cluster positions of the secondary candidate group, and determine the cold pool in a case where water temperature information of a corresponding buoy is within a water temperature range of the secondary candidate group.

According to the present disclosure, there is an effect of partitioning a target area, clustering partitioned areas to establish clusters, and using a standard deviation to determine a cold pool.

### BRIEF DESCRIPTION OF THE DRAWINGS

FIG. 1 is an overall algorithm of a cold pool detection method according to an exemplary embodiment of the present disclosure.

FIG. 2 is a view illustrating sea surface temperatures at 1 km resolution in a target area according to the exemplary embodiment of the present disclosure.

FIG. 3 is a view illustrating partitioning the target area according to the exemplary embodiment of the present disclosure.

FIGS. 4A to 4C are views illustrating setting clusters of partitioned areas according to the exemplary embodiment of the present disclosure.

FIG. 5 is a schematic view illustrating a configuration of a cold pool detection system according to the exemplary embodiment of the present disclosure.

### DETAILED DESCRIPTION OF THE INVENTION

Since the present disclosure can make various changes and have various exemplary embodiments, specific exemplary embodiments will be illustrated in the drawings and described in detail in the specification. However, this is not intended to limit the present disclosure to a particular disclosed form. On the contrary, the present disclosure is to be understood to include all various alternatives, equivalents, and substitutes that may be included within the idea and technical scope of the present disclosure.

In describing the present disclosure, when it is determined that a detailed description of a related known technology may obscure the subject matter of the present disclosure, the detailed description thereof will be omitted. In addition, numbers (e.g., first, second, etc.) used in a process of describing the present specification are merely identification symbols for distinguishing one component from other components.

In addition, in the present specification, when one component is referred to as “connected to”, “in contact with” the other component, or the like, the one component may be directly connected to or directly in contact with the other component, but it should be understood that, unless specifically stated to the contrary, the one component may be connected to or in contact with the other component through another component in the middle therebetween.

Hereinafter, a preferred exemplary embodiment of the present disclosure will be described in detail on the basis of the attached drawings.

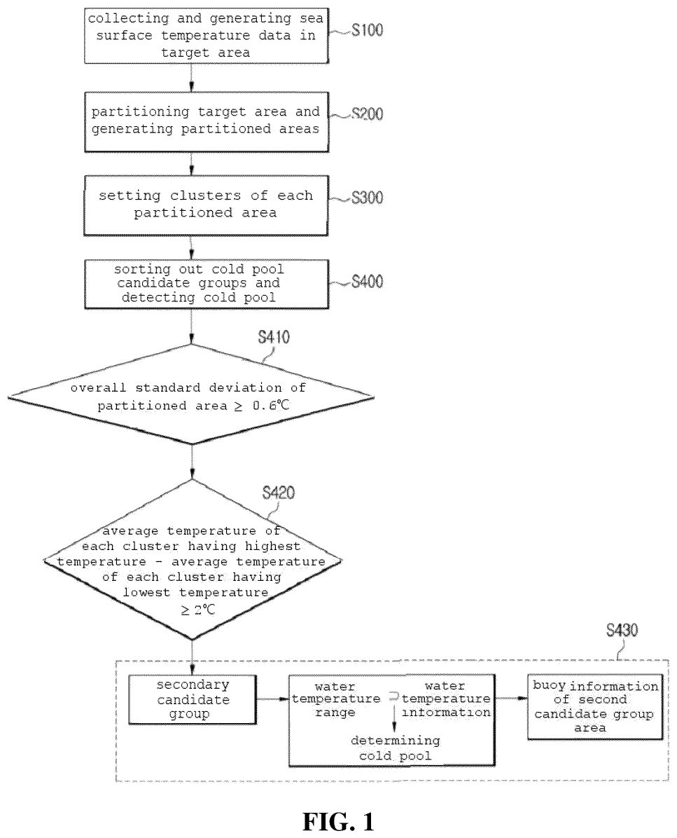

FIG. 1 is an overall algorithm of a cold pool detection method according to the exemplary embodiment of the present disclosure.

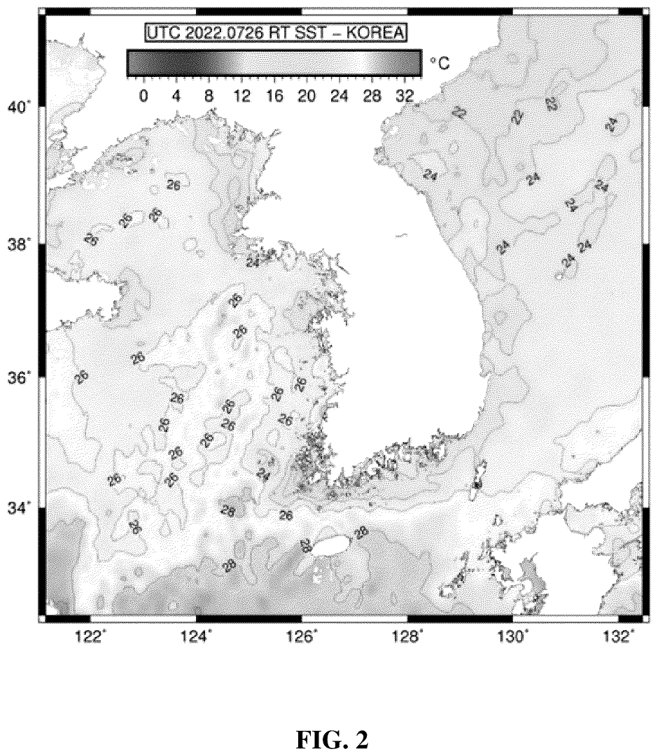

FIG. 2 is a view illustrating sea surface temperatures at 1 km resolution in a target area according to the exemplary embodiment of the present disclosure.

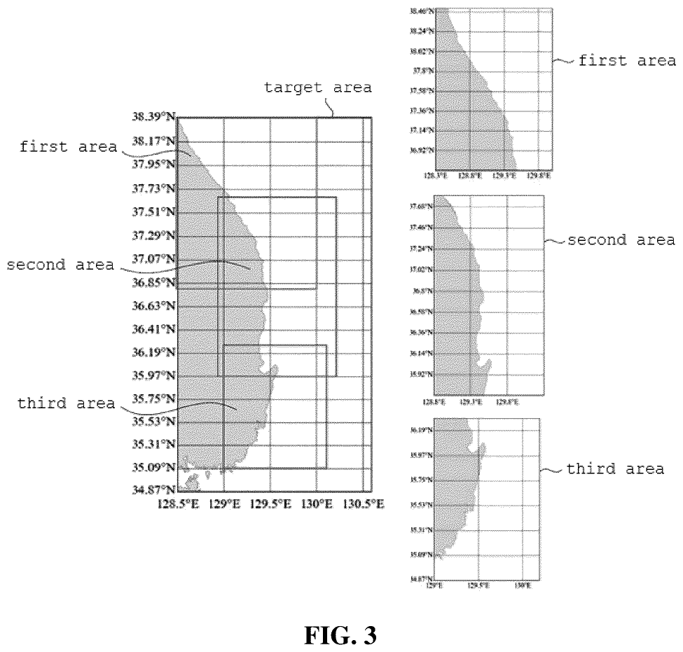

FIG. 3 is a view illustrating partitioning the target area according to the exemplary embodiment of the present disclosure.

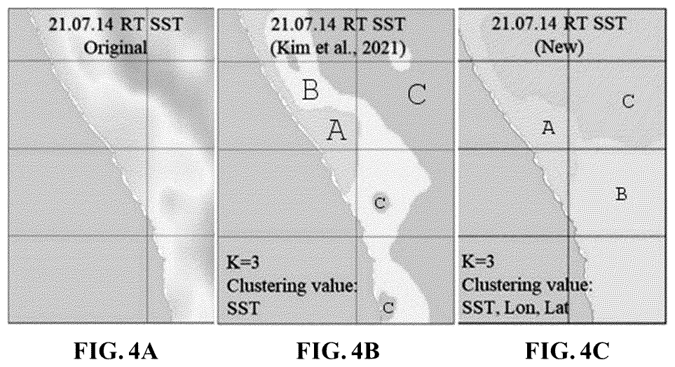

FIGS. 4A to 4C are views illustrating setting clusters of partitioned areas according to the exemplary embodiment of the present disclosure.

Referring to FIGS. 1 to 4, the cold pool detection method according to the present disclosure first performs step S100 of collecting and generating sea surface temperature data in a target area. More specifically, in step S100, data on sea surface temperatures at 1 km resolution in the target area may be generated by using various types of artificial satellites.

The target area refers to an area where a cold pool is to be detected.

Next, step S200 of partitioning the target area and generating partitioned areas is performed. The partitioning of the target area may be performed by setting latitudes and longitudes. Each partitioned area may be set to have overlapping latitudes and longitudes.

More specifically, as shown in FIG. 3, when the east coast of South Korea is used as a target area, the target area may be partitioned into three areas in step S200. When the partitioned areas are referred to as a first area, a second area, and a third area, the first area may be set as a northern part of the East Sea, having latitudes from 34.87 to 38.60 and longitudes from 128.40 to 131.69, the second area may be set as a central part of the East Sea, having latitudes from 35.70 to 37.80 and longitudes from 128.80 to 130.30, and the third area may be set as a southern part of the East Sea, having latitudes from 34.87 to 36.30 and longitudes from 129.00 to 130.19.

It is natural that the partitioning of the target area in step S200 may be determined by setting. In the present disclosure, description thereof is based on the partitioning of the east coast area of South Korea into the three areas: the first area (i.e., the northern East Sea), the second area (i.e., the central East Sea), and the third area (i.e., the southern East Sea).

Next, step S300 of setting clusters of each partitioned area is performed. Step S300 is a pre-step for setting up cold pool candidate groups, and clustering is performed by using a K-means clustering method.

Step S300 may include: step S310 of setting clustering values for setting clusters in each partitioned area; and step S320 of setting the number of the clusters in each partitioned area.

In the exemplary embodiment, the clustering values for setting the clusters of each partitioned area in step S310 may be “sea surface temperatures at 1 km resolution”.

In the exemplary embodiment, the clustering values for setting the clusters of each partitioned area in step S310 may be “sea surface temperatures at 1 km resolution”, latitudes, and longitudes.

In step S320, a value of K is set in a case where the K-means clustering method is used. The present disclosure is described by using K=3, but it is natural that the value of K may vary depending on setting.

More specifically, referring to FIGS. 4A to 4C, FIG. 4A shows the first area among the partitioned areas, with land on the left and sea on the right, and the sea is displayed in different colors depending on temperatures. As for this view, when clustering values are set by using only the “sea surface temperatures at 1 km resolution” in step S310 and the number of the clusters is set to three in step S320, a resulting view is shown as in FIG. 4B. Through clustering, the sea portion on the right side of FIG. 4B was partitioned into three clusters: A, B, and C.

In addition, when clustering values are set by using not only the “sea surface temperatures at 1 km resolution” but also latitudes and longitudes in step S310 and the number of the clusters is set to three in step S320, a resulting view is shown as in FIG. 4C. Through clustering, the sea portion on the right side of FIG. 4C was partitioned into three clusters: A, B, and C. However, it may be seen that there is a difference between FIG. 4C and FIG. 4B. This is because the clustering values are different from each other, so it may be seen that different results of clustering are produced depending on how clustering values are set.

When the case where the target area is partitioned into three areas and the number of clusters is three is described, the three clusters A, B, and C are generated for each partitioned area as steps S100 to S300 are performed. These clusters are referred to as first area-A, first area-B, first area-C, second area-A, second area-B, second area-C, third area-A, third area-B, and third area-C.

Water temperature ranges of the generated clusters for each partitioned area may be different for each partitioned area. For example, water temperature ranges of clusters A, B, and C in the first area may be 22° C.˜23.9° C. (for the first area-A), 24° C.˜25.9° C. (for the first area-B), and 26° C.˜27.9° C. (for the first area-C), and water temperature ranges of clusters A, B, and C in the second area may be 20° C.˜23.9° C. (for the second area-A), 24° C.˜27.9° C. (for the second area-B), and 28° C.˜32° C. (for the second area-C). Likewise, water temperature ranges for clusters A, B, and C in the third area may be 22° C.˜25.9° C. (for the third area-A), 26° C.˜29.9° C. (for the third area-B), and 30° C.˜38° C. (for the third area-C).

Next, step S400 of sorting out cold pool candidate groups and detecting a cold pool is performed.

Step 400 includes: step S410 of sorting out a primary candidate group from the partitioned areas partitioned in step S200; step S420 of sorting out a secondary candidate group from the primary candidate group; and step S430 of determining a cold pool by confirming the secondary candidate group and buoy information.

In step S410, whether or not an overall standard deviation for each partitioned area is 0.6° C. or more is determined, and any partitioned area is classified into the primary candidate group in a case where an overall standard deviation of the partitioned area is 0.6° C. or more. Likewise, any partitioned area is eliminated from the primary candidate group in a case when an overall standard deviation of the partitioned area is less than 0.6° C. For example, when a standard deviation of the entire first area is 0.6° C. or more, the first area is classified into the primary candidate group. Likewise, when a standard deviation of the entire first area is less than 0.6° C., the first area is eliminated from the primary candidate group and excluded from cold pool candidates.

In step S420, the partitioned area is classified into a secondary candidate group in a case where among each of the clusters in the partitioned area classified into the primary candidate group, a value obtained by subtracting an average temperature of each cluster having a lowest temperature from an average temperature of each cluster having a highest temperature is 2° C. or more. Likewise, the partitioned area is eliminated from the secondary candidate group in a case where among each of the clusters in the partitioned area classified into the primary candidate group, a value obtained by subtracting the average temperature of each cluster having a lowest temperature from the average temperature of each cluster having a highest temperature is less than 2° C.

Subsequently, in step S430, buoy information on cluster positions of the secondary candidate group may be confirmed and a cold pool may be determined in a case where water temperature information of a corresponding buoy is within a water temperature range of the corresponding secondary candidate group. For example, in a case where the first area is classified into the secondary candidate group, the buoy information of the first area is confirmed and when water temperature information of a corresponding buoy is within a water temperature range of the first area, the first area may be determined as a cold pool.

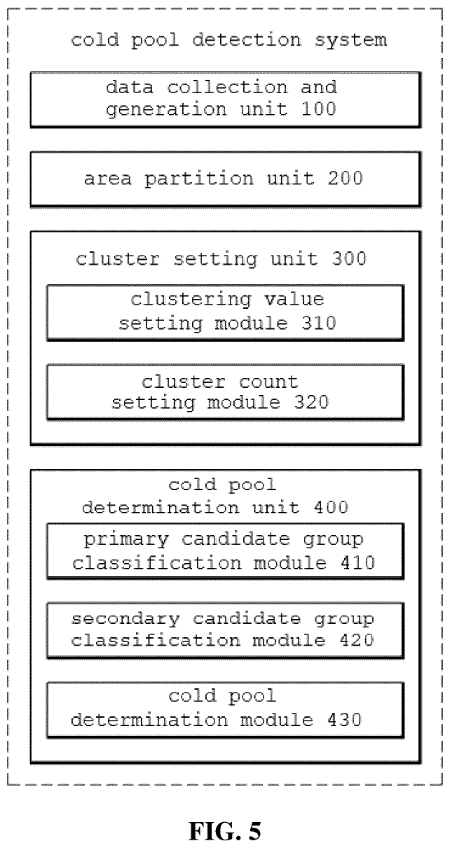

FIG. 5 is a schematic view illustrating a configuration of a cold pool detection system according to the exemplary embodiment of the present disclosure.

The cold pool detection method according to the present disclosure is based on the cold pool detection system.

Referring to FIG. 5, the cold pool detection system according to the present disclosure includes a data collection and generation unit 100, an area partition unit 200, a cluster setting unit 300, and a cold pool determination unit 400.

The data collection and generation unit 100 collects and generates sea surface temperature data in a target area. More specifically, the data collection and generation unit 100 may generate data on sea surface temperatures at 1 km resolution of the target area by using various types of artificial satellites.

The area partition unit 200 partitions the target area and generates partitioned areas. The partitioning of the target area may be performed by setting latitudes and longitudes. Each partitioned area may be set to have overlapping latitudes and longitudes.

More specifically, when a target area is the east coast of South Korea as shown in FIG. 3, the target area may be partitioned into three areas by the area partition unit 200. When the partitioned areas are referred to as a first area, a second area, and a third area, the first area may be set as a northern part of the East Sea, with latitudes from 34.87 to 38.60 and longitudes from 128.40 to 131.69, the second area may be set as a central part of the East Sea, with latitudes from 35.70 to 37.80 and longitudes from 128.80 to 130.30, and the third area may be set as a southern part of the East Sea, with latitudes from 34.87 to 36.30 and longitudes from 129.00 to 130.19.

It is natural that the partitioning of the target area may be determined by setting. In the present disclosure, description thereof is based on the partitioning of the east coast area of South Korea into the three areas: the first area (i.e., the northern East Sea), the second area (i.e., the central East Sea), and the third area (i.e., the southern East Sea).

The cluster setting unit 300 sets clusters of each partitioned area. The cluster setting unit 300 may perform clustering by using a K-means clustering method.

The cluster setting unit 300 is configured to include: a clustering value setting module 310; and a cluster count setting module 320.

The clustering value setting module 310 may set clusters of each partitioned area.

The cluster count setting module 320 may set the number of the clusters in each partitioned area.

In the exemplary embodiment, clustering values for setting clusters of each partitioned area may be “sea surface temperatures at 1 km resolution”.

In the exemplary embodiment, clustering values for setting clusters of each partitioned area may be “sea surface temperatures at 1 km resolution”, latitudes, and longitudes. Detailed description refers to the description of step S300 above.

The cold pool determination unit 400 sorts out cold pool candidate groups and detects a cold pool.

The cold pool determination unit 400 is configured to include: a primary candidate group classification module 410; a secondary candidate group classification module 420; and a cold pool determination module 430.

The primary candidate group classification module 410 sorts out a primary candidate group from the partitioned areas partitioned by the area partition unit 200.

More Specifically, the primary candidate group classification module 410 determines whether or not an overall standard deviation for each partitioned area is 0.6° C. or more, and classifies any partitioned area into the primary candidate group in a case where an overall standard deviation of the partitioned area is 0.6° C. or more. Likewise, the partitioned area is eliminated from the primary candidate group in a case when an overall standard deviation of the partitioned area is less than 0.6° C. For example, when a standard deviation of the entire first area is 0.6° C. or more, the first area is classified into the primary candidate group. Likewise, when a standard deviation of the entire first area is less than 0.6° C., the first area is eliminated from the primary candidate group and excluded from cold pool candidates.

In a case where among each of the clusters in the partitioned area classified into the primary candidate group, a value obtained by subtracting an average temperature of each cluster having a lowest temperature from an average temperature of each cluster having a highest temperature is 2° C. or more, the secondary candidate group classification module 420 classifies the partitioned area into a secondary candidate group. Likewise, in a case where among each of the clusters in the partitioned area classified into the primary candidate group, a value obtained by subtracting an average temperature of each cluster having a lowest temperature from an average temperature of each cluster having a highest temperature is less than 2° C., the partitioned area is eliminated from the secondary candidate group. In other words, the partitioned area is excluded from the cold pool candidates.

The cold pool determination module 430 determines a cold pool by confirming the secondary candidate group and buoy information. More specifically, the cold pool determination module 430 confirms the buoy information on cluster positions of the secondary candidate group and determines the cold pool in a case where water temperature information of a corresponding buoy is within a water temperature range of the corresponding secondary candidate group. For example, in a case where the first area is classified into the secondary candidate group, the buoy information of the first area is confirmed and when water temperature information of a corresponding buoy is within a water temperature range of the first area, the first area may be determined as a cold pool.

The scope of the present disclosure is not limited to the above-described exemplary embodiments, but may be implemented in various forms of exemplary embodiments within the scope of the appended claims. It is considered to be within the scope of the claims of the present disclosure to the extent that those skilled in the art to which the disclosure pertains can make various modifications without departing from the gist of the disclosure claimed in the claims.

What is claimed is:

1. A cold pool detection method, comprising:
collecting and generating sea surface temperature data in a target area;
partitioning the target area and generating partitioned areas;
setting up clusters of each partitioned area; and
sorting out cold pool candidate groups and detecting a cold pool.

2. The cold pool detection method of claim 1, wherein the setting up of the clusters of each partitioned area comprises:
setting clustering values for setting the clusters of each partitioned area; and
setting the number of the clusters of each partitioned area.

3. The cold pool detection method of claim 2, wherein the clustering values are sea surface temperatures at 1 km resolution.

4. The cold pool detection method of claim 3, wherein the sorting out of the cold pool candidate groups and the detecting of the cold pool comprises:
sorting out a primary candidate group from the partitioned areas partitioned from the partitioning of the target area and the generating of the partitioned areas; and
sorting out a secondary candidate group from the primary candidate group,
the sorting out of the primary candidate group classifies any partitioned area into the primary candidate group in a case where an overall standard deviation of the partitioned area is 0.6° C. or more, and
the sorting out of the secondary candidate group classifies the partitioned area into the second candidate group in a case where among each of the clusters in the partitioned area classified into the primary candidate group, a value obtained by subtracting an average temperature of each cluster having a lowest temperature from an average temperature of each cluster having a highest temperature is 2° C. or more.

5. The cold pool detection method of claim 4, wherein the sorting out of the cold pool candidate groups and the detecting of the cold pool further comprises determining the cold pool by confirming the secondary candidate group and buoy information, confirms the buoy information on cluster positions of the secondary candidate group, and determines the cold pool in a case where water temperature information of a corresponding buoy is within a water temperature range of the corresponding secondary candidate group.

6. A cold pool detection system, comprising:
a data collection and generation unit for collecting and generating sea surface temperature data in a target area;
an area partition unit for partitioning the target area and generating partitioned areas;
a cluster setting unit for setting clusters of each partitioned area; and
a cold pool determination unit for sorting out cold pool candidate groups and detecting a cold pool.

7. The cold pool detection system of claim 6, wherein the cluster setting unit comprises:
a clustering value setting module configured to set clustering values for setting the clusters of the partitioned areas; and
a cluster count setting module configured to set the number of the clusters of each partitioned area.

8. The cold pool detection system of claim 7, wherein the clustering values are sea surface temperatures at 1 km resolution.

9. The cold pool detection system of claim 8, wherein the cold pool determination unit comprises:
a primary candidate group classification module for sorting out a primary candidate group from the partitioned areas partitioned by the area partition unit; and
a secondary candidate group classification module for sorting out a secondary candidate group from the primary candidate group sorted out by the primary candidate group classification module,
the primary candidate group classification module classifies any partitioned area into the primary candidate group in a case where an overall standard deviation of the partitioned area is 0.6° C. or more, and
the secondary candidate group classification module classifies the partitioned area into the secondary candidate group in a case where among each of the clusters of the partitioned area classified into the primary candidate group, a value obtained by subtracting an average temperature of each cluster having a lowest temperature from an average temperature of each cluster having a highest temperature is 2° C. or more.

10. The cold pool detection system of claim 9, wherein the cold pool determination unit further comprises:
a cold pool determination module for determining the cold pool by confirming the secondary candidate group and buoy information, and
the cold pool determination module confirms the buoy information of cluster positions of the secondary candidate group, and determines the cold pool in a case where water temperature information of a corresponding buoy is within a water temperature range of the secondary candidate group.
